(19) United States
(12) Patent Application Publication
(10) Pub. No.: US 2020/0176794 A1
(43) Pub. Date: Jun. 4, 2020

(54) METHOD FOR DETECTING A LEAK IN A FUEL CELL SYSTEM AND FUEL CELL SYSTEM

(71) Applicant: Robert Bosch GmbH, Stuttgart (DE)

(72) Inventor: Johannes Schild, Abstatt (DE)

(21) Appl. No.: 16/615,638

(22) PCT Filed: Apr. 4, 2018
(86) PCT No.: PCT/EP2018/058517

§ 371 Date: Nov. 21, 2019

(30) Foreign Application Priority Data
May 22, 2017 (DE) 10 2017 208 604.1

(51) Int. Cl. H01M 8/04746; H01M 8/04089; H01M 8/0432; H01M 8/0438

(52) U.S. Cl. CPC H01M 8/04753; H01M 8/04089; H01M 2250/20; H01M 8/04388; H01M 8/04395; H01M 8/04365

(57) ABSTRACT

The invention relates to a method for detecting a leak in a fuel cell system (1), which has: a fuel cell unit (3), having an anode (21) and a cathode (22); a compressed gas store (36); a pressure reducer (70); and an injector (72), said method comprising the following steps: determining an outflow amount (Mab) of fuel flowing out of the compressed gas store (36) in a specified time interval; determining a through-flow amount (Mdurch) of fuel flowing through the injector (72) in the specified time interval; comparing the outflow amount (Mab) of fuel with the through-flow amount (Mdurch) of fuel; producing an error signal if a difference of the outflow amount (Mab) and the through-flow amount (Mdurch) exceeds a specified limit value. The invention further relates to a fuel cell system (1), which comprises: a fuel cell unit (3), having an anode (21) and a cathode (22); a compressed gas store (36); a pressure reducer (70); and an injector (72). Means for determining an outflow amount (Mab) of fuel flowing out of the compressed gas store (36) in a specified time interval and means for determining a through-flow amount (Mdurch) of fuel flowing through the injector (72) in the specified time interval are provided.

### BACKGROUND OF THE INVENTION

The invention relates to a method for identifying a leak in a fuel cell system which has a fuel cell unit with an anode and a cathode, a compressed gas reservoir, a pressure reducer and an injector. The invention also relates to a fuel cell system to which the method according to the invention can be applied.

A fuel cell is a galvanic cell which converts the chemical energy of reaction from a continuously supplied fuel and an oxidant into electrical energy. A fuel cell is therefore an electrochemical energy transducer. In known fuel cells, hydrogen (H₂) and oxygen (O₂) in particular are converted into water (H₂O), electrical energy and heat.

Fuel cells further have an anode and a cathode. The fuel is supplied to the anode of the fuel cell and catalytically oxidized with release of electrons to give protons. The protons pass through the membrane to the cathode. The released electrons are led off from the fuel cell and flow via an external electrical circuit to the cathode. The oxidant is supplied to the cathode of the fuel cell and reacts by accepting the electrons from the external electrical circuit and protons which pass through the membrane to the cathode to give water. The resultant product water is led off from the fuel cell. The overall reaction is:

O₂+4H⁺+4e⁻→2H₂O

A voltage is applied between the anode and the cathode of the fuel cell here. In order to increase the voltage, a plurality of fuel cells can be arranged mechanically one behind the other and connected electrically in series to form a fuel cell stack.

A fuel cell system of the generic type, in particular for use in motor vehicles, is known from DE 10 2014 013 670 A1. The fuel cell system comprises a fuel cell unit, which has a plurality of fuel cells, with an anode and a cathode. Hydrogen as fuel is stored in a compressed gas reservoir and supplied to the anode via a pressure control valve. Air, which contains oxygen as oxidant, is supplied to the cathode by an electrically driven compressor.

DE 10 2016 110 620 A1 likewise discloses a fuel cell system of the generic type. In this case, the fuel cell system additionally comprises a circulation pump. An excess of hydrogen is discharged from the anode and admixed with the fresh hydrogen by the circulation pump.

DE 10 2006 023 433 A1 describes a pressure controller which comprises a plurality of valve stages in order to increase the reduction ratio of the controller and has a particular application for an anode inlet side of a fuel cell system. Pressure control is performed by means of a throughflow pressure controller, wherein a membrane arrangement with a double membrane is provided. If a first membrane transmits hydrogen, a leak can be detected before the hydrogen reaches the second membrane and the air side of the pressure controller.

DE 102 31 208 A1 describes a method and an apparatus for examining a fuel cell system. The method and the apparatus are designed in order to check whether the fuel cell system is gastight on the anode side and/or cathode side and/or whether there is a leak between the anode side and the cathode side of the fuel cell system.

### SUMMARY OF THE INVENTION

The invention proposes a method for identifying a leak in a fuel cell system. In this case, the fuel cell system comprises a fuel cell unit with an anode and a cathode, a compressed gas reservoir, a pressure reducer and an injector. In this case, the compressed gas reservoir is connected to the pressure reducer via a high-pressure line, the pressure reducer is connected to the injector via a medium-pressure line, and the injector is connected to the fuel cell unit via an injection line.

In a step a), an outflow quantity of fuel flowing out of the compressed gas reservoir in a prespecified time interval is determined. The fuel flows, in particular, from the compressed gas reservoir to the pressure reducer through the high-pressure line. The time interval is, for example, one minute.

In a step b), a throughflow quantity of fuel flowing through the injector in the prespecified time interval is determined. The fuel flows, in particular, from the pressure reducer to the injector through the medium-pressure line and further to the fuel cell unit through the injection line.

In a step c), the outflow quantity of fuel which is determined in step a) is compared with the throughflow quantity of fuel which is determined in step b). In so doing, a difference between the outflow quantity and the throughflow quantity is formed in particular.

An error signal is generated in a step d) when the difference between the outflow quantity Mout and the throughflow quantity Mthrough exceeds a prespecified limit value GW. The error signal is therefore generated when:

Mout−Mthrough>GW

It can be concluded that there is a leak in the fuel cell system when the difference between the outflow quantity of fuel flowing out of the compressed gas reservoir and the throughflow quantity of fuel flowing through the injector exceeds the prespecified limit value. The error signal therefore indicates an identified leak in the fuel cell system.

According to a preferred refinement of the invention, in the step a) for determining the outflow quantity of fuel flowing out of the compressed gas reservoir in the prespecified time interval, a first quantity of fuel which is contained in the compressed gas reservoir is calculated at the beginning of the time interval. A second quantity of fuel which is contained in the compressed gas reservoir is calculated at the end of the time interval. The outflow quantity Mout is then calculated as the difference between the first quantity M1 and the second quantity M2. Therefore:

Mout=M1−M2

According to an advantageous refinement of the invention, for calculating the first quantity of fuel and also for calculating the second quantity of fuel, a high pressure is measured in the compressed gas reservoir or in the high-pressure line which is arranged between the compressed gas reservoir and the pressure reducer. Similarly, a fuel temperature is measured in the compressed gas reservoir or in the high-pressure line. The first quantity M1 of fuel and/or the second quantity M2 of fuel are/is then calculated from the high pressure P1, the fuel temperature T1 and further variables. The further variables particularly include:

| | |
|---|---|
| the normal pressure | P0 = 1013 hPA, |
| the normal temperature | T0 = 298K, |
| the molar mass of the fuel | M = 2 g (for hydrogen as fuel), |
| the molar volume | Vm = 22.41 |

and also a net volume V0 of the compressed gas reservoir:

M1=P1/P0*T1/T0*M/Vm*V0 (at the beginning of the time interval)

M2=P1/P0*T1/T0*M/Vm*V0 (at the end of the time interval)

According to a preferred refinement of the invention, in the step b) for determining the throughflow quantity of fuel flowing through the injector in the prespecified time interval, during the time interval a medium pressure is measured in the medium-pressure line which is arranged between the pressure reducer and the injector, and an injection pressure is measured in an injection line which is arranged between the injector and the fuel cell unit. The throughflow quantity is then calculated from the medium pressure and the injection pressure by means of a corresponding characteristic curve of the injector.

According to an advantageous refinement of the invention, the injector is controlled by means of pulse width modulation, wherein the pulse width modulation has a duty ratio. In this case, the characteristic curve of the injector describes a dependency of the throughflow quantity Mthrough on the medium pressure P2, on the injection pressure P3 and on the duty ratio Ta during the time interval. The characteristic curve of the injector can be described by a mathematical function F:

Mthrough=F(P2,P3,Ta)

The medium pressure P2, the injection pressure P3 and the duty ratio Ta can change during the time interval. Therefore, for example, a throughflow rate is continuously ascertained by means of a corresponding function during the time interval for the purpose of ascertaining the throughflow quantity Mthrough. The ascertained throughflow rate is integrated over the time interval, and the throughflow quantity Mthrough corresponds to the integral of the ascertained throughflow rate over the time interval. A discrete throughflow rate is in each case ascertained for a large number of individual time points within the time interval, for example, by means of a corresponding function for the purpose of ascertaining the throughflow quantity Mthrough in practice. The ascertained discrete throughflow rates are added up, and the throughflow quantity Mthrough then corresponds to the sum of the discrete throughflow rates.

The characteristic curve describes a mutual dependency of physical variables of the injector. The characteristic curve of the injector is known to a person skilled in the art owing to the precise manufacturing of the injector and knowledge about the injector used. In this case, the characteristic curve represents a theoretical model of the injector. The accuracy of the characteristic curve can be adapted and optimized by measuring the injector. The optimization takes place, for example, by introducing further parameters into the theoretical model.

The method can also be carried out almost continuously by way of the values of the outflow quantity Mout and of the throughflow quantity Mthrough being determined repeatedly, in particular cyclically. For example, the values of the first quantity M1 can be stored in a ring buffer. The value of the second quantity M2 can be directly determined at a respectively current time point, and the value of the first quantity M1 can be taken from the ring buffer for a defined time point from the past.

The invention also proposes a fuel cell system which comprises a fuel cell unit with an anode and a cathode, a compressed gas reservoir, a pressure reducer and an injector. In this case, the compressed gas reservoir is connected to the pressure reducer via a high-pressure line, the pressure reducer is connected to the injector via a medium-pressure line, and the injector is connected to the fuel cell unit via an injection line.

According to the invention, means for determining an outflow quantity of fuel flowing out of the compressed gas reservoir in a prespecified time interval are provided, and means for determining a throughflow quantity of fuel flowing through the injector in the prespecified time interval are provided.

A leak in the fuel cell system can be identified by way of determining the outflow quantity of fuel flowing out of the compressed gas reservoir in a prespecified time interval and determining the throughflow quantity of fuel flowing through the injector in the prespecified time interval.

Means for comparing the outflow quantity of fuel with the throughflow quantity of fuel are also preferably provided. Said means can be implemented, for example, in the form of an electronic circuit.

Means for generating an error signal when a difference between the outflow quantity and the throughflow quantity exceeds a prespecified limit value are also preferably provided. Said means can be implemented, for example, in the form of an electronic circuit.

According to an advantageous refinement of the invention, the means for determining the outflow quantity of fuel flowing out of the compressed gas reservoir in the prespecified time interval comprise a first pressure sensor which is arranged in the compressed gas reservoir or in the high-pressure line which is arranged between the compressed gas reservoir and the pressure reducer, and a temperature sensor which is arranged in the compressed gas reservoir or in the high-pressure line which is arranged between the compressed gas reservoir and the pressure reducer.

The first pressure sensor and the temperature sensor are therefore arranged upstream of the pressure reducer and measure a high pressure of the fuel and also a fuel temperature. The high pressure of the fuel in the compressed gas reservoir and also in the high-pressure line lies, for example, in a range of up to 350 bar or up to 700 bar in the case of a full compressed gas reservoir. The compressed gas reservoir is, for example, then emptied down to approximately 20 bar during operation.

According to an advantageous development of the invention, the means for determining the throughflow quantity of fuel flowing through the injector in the prespecified time interval comprise a second pressure sensor which is arranged in the medium-pressure line which is arranged between the pressure reducer and the injector, and a third pressure sensor which is arranged in the injection line which is arranged between the injector and the fuel cell unit.

The second pressure sensor is therefore arranged downstream of the pressure reducer and upstream of the injector and measures a medium pressure of the fuel. The medium pressure of the fuel in the medium-pressure line lies, for example, in a range of from 9 bar to 13 bar or of from 10 bar to 20 bar.

The third pressure sensor is therefore arranged downstream of the injector and upstream of the fuel cell unit and measures an injection pressure of the fuel. The injection pressure of the fuel in the injection line lies, for example, in a range of from 1 bar to 3 bar.

The injector can preferably be actuated by means of pulse width modulation which has a duty ratio. In this case, a dependency of the throughflow quantity on a medium pressure which is measured by the second pressure sensor, on an injection pressure which is measured by the third pressure sensor and on the duty ratio can be described by a characteristic curve of the injector.

A method according to the invention for operating a fuel cell system and also a fuel cell system according to the invention are advantageously used in a motor vehicle.

The method according to the invention allows identification of a leak in a fuel cell system, in particular a leak in a line between the compressed gas reservoir and the anode of the fuel cell unit during operation of the fuel cell system. A separate throughflow meter is not required in this case. Furthermore, an external sensor system for determining the fuel, in particular for detecting hydrogen, is not required outside the fuel cell system either. In this case, identifying a leak in the fuel cell system can be carried out with a relatively high degree of accuracy and in a relatively short time, for example within one minute.

### BRIEF DESCRIPTION OF THE DRAWINGS

Embodiments of the invention will be explained in more detail with reference to the following description and the drawing, in which:

FIG. 1 shows a schematic illustration of a fuel cell system.

### DETAILED DESCRIPTION

In the following description of the embodiments of the invention, identical or similar elements have been provided with the same reference symbols, with repeated description of these elements being dispensed with in individual cases. The figures are merely schematic representations of the subject matter of the invention.

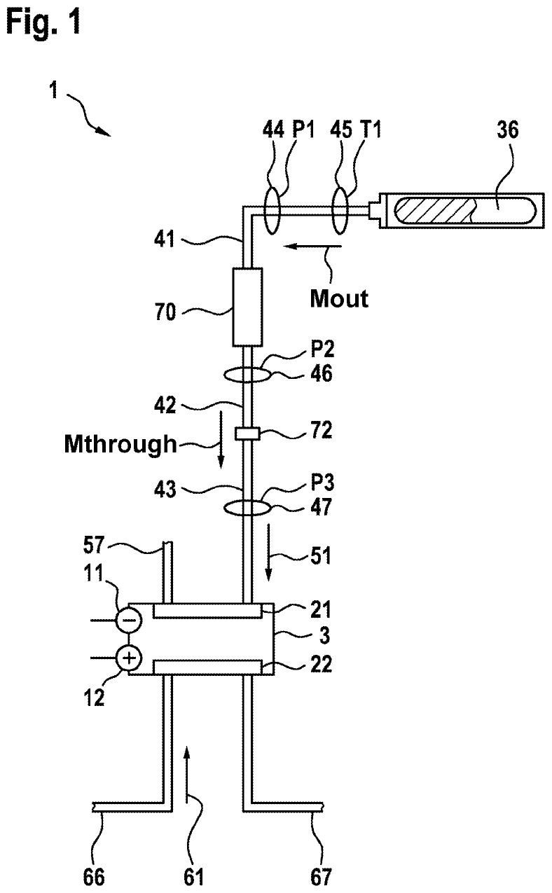

FIG. 1 shows a schematic illustration of a fuel cell system 1. The fuel cell system 1 comprises a fuel cell unit 3 which has a plurality of fuel cells, not explicitly illustrated here. The fuel cell unit 3 has an anode 21 and a cathode 22. The individual fuel cells each have negative electrodes which together form the anode 21 of the fuel cell unit 3. The individual fuel cells each have positive electrodes which together form the cathode 22 of the fuel cell unit 3.

The fuel cell unit 3 has a negative terminal 11 which is electrically connected to the anode 21. Similarly, the fuel cell unit 3 has a positive terminal 12 which is electrically connected to the cathode 22. During operation of the fuel cell system 1, an electrical voltage is applied between the negative terminal 11 and the positive terminal 12 of the fuel cell unit 3.

The negative terminal 11 and the positive terminal 12 of the fuel cell unit 3 are connected to an on-board electrical system, not illustrated here, of a motor vehicle. A cooling device, not illustrated here, is provided for cooling the fuel cell unit 3.

The fuel cell system 1 comprises a compressed gas reservoir 36 for storing a fuel, in particular hydrogen. The compressed gas reservoir 36 is connected to a pressure reducer 70 via a high-pressure line 41. A high pressure P1 of, for example, from 350 bar to 700 bar prevails in the compressed gas reservoir 36 and also in the high-pressure line 41. The pressure reducer 70 is connected to an injector 72 via a medium-pressure line 42. The pressure reducer 70 reduces the pressure in the medium-pressure line 42 in such a way that, for example, a medium pressure P2 of from 10 bar to 20 bar prevails in the medium-pressure line 42.

The injector 72 is connected to the fuel cell unit 3, in particular to the anode 21, via an injection line 43. The injector 72 reduces the pressure in the injection line 43 in such a way that, for example, an injection pressure P3 of from 1 bar to 3 bar prevails in the injection line 43. The injection line 43 serves to supply the fuel, in particular hydrogen, to the anode 21 of the fuel cell unit 3.

During operation of the fuel cell system 1, the fuel, in particular hydrogen, flows from the compressed gas reservoir 36 to the anode 21 of the fuel cell unit 3 in a first flow direction 51. The fuel cell system 1 also comprises a first discharge line 57 for discharging excess fuel from the anode 21.

A water separator, not illustrated here, is provided on the first discharge line 57. Water is separated from the fuel in the water separator. In the process, the fuel is supplied back to the anode 21 of the fuel cell unit 3 via the injection line 43 by means of a circulation pump, not illustrated here.

The fuel cell system 1 further comprises a supply line 66 for supplying an oxidant, in particular air containing oxygen, to the cathode 22. To this end, the supply line 66 is connected, for example, to a compressor, not illustrated here. The compressor draws in air via an air filter, compresses the drawn-in air and supplies the compressed air to the cathode 22 of the fuel cell unit 3 in a second flow direction 61.

The fuel cell system 1 also comprises a second discharge line 67 for discharging excess oxidant from the cathode 22. The second discharge line 67 also serves to discharge product water which is produced by the electrochemical reaction in the fuel cells of the fuel cell unit 3.

A first pressure sensor 45 is arranged in the high-pressure line 41 which is arranged between the compressed gas reservoir 36 and the pressure reducer 70. As an alternative, the first pressure sensor 45 can also be arranged in the compressed gas reservoir 36. The first pressure sensor 45 serves to measure the high pressure P1.

A temperature sensor 44 is likewise arranged in the high-pressure line 41 which is arranged between the compressed gas reservoir 36 and the pressure reducer 70. As an alternative, the temperature sensor 44 can also be arranged in the compressed gas reservoir 36. The temperature sensor 44 serves to measure a fuel temperature T1.

A second pressure sensor 46 is arranged in the medium-pressure line 42 which is arranged between the pressure reducer 70 and the injector 72. The second pressure sensor 46 serves to measure the medium pressure P2. A third pressure sensor 47 is arranged in the injection line 43 which is arranged between the injector 72 and the fuel cell unit 3. The third pressure sensor 47 serves to measure the injection pressure P3.

The first pressure sensor 45 and the temperature sensor 44 are arranged upstream of the pressure reducer 70. The second pressure sensor 46 is arranged downstream of the pressure reducer 70 and upstream of the injector 72. The third pressure sensor 47 is arranged downstream of the injector 72 and upstream of the fuel cell unit 3.

In the present case, the injector 72 can be actuated by means of pulse width modulation. The pulse width modulation has a variable duty ratio Ta. A characteristic curve of the injector 72 describes a relationship between the medium pressure P2 which is measured by the second pressure sensor 46, the injection pressure P3 which is measured by the third pressure sensor 47 and the duty ratio Ta.

The first pressure sensor 45 and the temperature sensor 44 serve to determine an outflow quantity Mout of fuel flowing out of the compressed gas reservoir 36 in a prespecified time interval. The second pressure sensor 46 and the third pressure sensor 47 serve to determine a throughflow quantity Mthrough of fuel flowing through the injector 72 in the prespecified time interval.

The invention is not restricted to the exemplary embodiments described here and the aspects highlighted therein. Rather, numerous modifications which lie within the capabilities of a person skilled in the art are possible within the scope of the claims.

1. A method for identifying a leak in a fuel cell system (1) which has a fuel cell unit (3) with an anode (21) and a cathode (22), a compressed gas reservoir (36), a pressure reducer (70) and an injector (72), the method comprising the following steps:
a. determining an outflow quantity (Mout) of fuel flowing out of the compressed gas reservoir (36) in a prespecified time interval;
b. determining a throughflow quantity (Mthrough) of fuel flowing through the injector (72) in the prespecified time interval;
c. comparing the outflow quantity (Mout) of fuel with the throughflow quantity (Mthrough) of fuel; and
d. generating an error signal when a difference between the outflow quantity (Mout) and the throughflow quantity (Mthrough) exceeds a prespecified limit value (GW).

2. The method as claimed in claim 1, wherein, in step a),
a first quantity (M1) of fuel which is contained in the compressed gas reservoir (36) is calculated at the beginning of the prespecified time interval,
a second quantity (M2) of fuel which is contained in the compressed gas reservoir (36) is calculated at the end of the prespecified time interval, and
the outflow quantity (Mout) is calculated as the difference between the first quantity (M1) and the second quantity (M2).

3. The method as claimed in claim 2, wherein
a high pressure (P1) is measured in the compressed gas reservoir (36) or in a high-pressure line (41) which is arranged between the compressed gas reservoir (36) and the pressure reducer (70),
a fuel temperature (T1) is measured in the compressed gas reservoir (36) or in the high-pressure line (41), and
the first quantity (M1) of fuel and/or the second quantity (M2) of fuel are/is calculated from the high pressure (P1), the fuel temperature (T1) and further variables.

4. The method as claimed in claim 1, wherein, in step b),
during the prespecified time interval
a medium pressure (P2) is measured in a medium-pressure line (42) which is arranged between the pressure reducer (70) and the injector (72),
an injection pressure (P3) is measured in an injection line (43) which is arranged between the injector (72) and the fuel cell unit (3), and
the throughflow quantity (Mthrough) is calculated from the medium pressure (P2) and the injection pressure (P3) by means of a corresponding characteristic curve of the injector (72).

5. The method as claimed in claim 4, wherein
the injector (72) is controlled by means of pulse width modulation,
the pulse width modulation has a duty ratio (Ta), and
the characteristic curve of the injector (72) describes a dependency of the throughflow quantity (Mthrough) on the medium pressure (P2), on the injection pressure (P3) and on the duty ratio (Ta).

6. A fuel cell system (1), comprising
a fuel cell unit (3) with an anode (21) and a cathode (22), a compressed gas reservoir (36), a pressure reducer (70) and an injector (72),
means for determining an outflow quantity (Mout) of fuel flowing out of the compressed gas reservoir (36) in a prespecified time interval, and
means for determining a throughflow quantity (Mthrough) of fuel flowing through the injector (72) in the prespecified time interval.

7. The fuel cell system (1) as claimed in claim 6, characterized in that
the means for determining the outflow quantity (Mout) of fuel flowing out of the compressed gas reservoir (36) in the prespecified time interval comprise
a first pressure sensor (45) which is arranged in the compressed gas reservoir (36) or in a high-pressure line (41) which is arranged between the compressed gas reservoir (36) and the pressure reducer (70), and
a temperature sensor (44) which is arranged in the compressed gas reservoir (36) or in the high-pressure line (41) which is arranged between the compressed gas reservoir (36) and the pressure reducer (70).

8. The fuel cell system (1) as claimed in claim 6, characterized in that
the means for determining the throughflow quantity (Mthrough) of fuel flowing through the injector (72) in the prespecified time interval comprise
a second pressure sensor (46) which is arranged in a medium-pressure line (42) which is arranged between the pressure reducer (70) and the injector (72), and
a third pressure sensor (47) which is arranged in an injection line (43) which is arranged between the injector (72) and the fuel cell unit (3).

9. The fuel cell system (1) as claimed in claim 8, characterized in that
the injector (72) can be actuated by means of pulse width modulation which has a duty ratio (Ta), wherein
a dependency of the throughflow quantity (Mthrough) on a medium pressure (P2) which is measured by the second pressure sensor (46), on an injection pressure (P3) which is measured by the third pressure sensor (47) and on the duty ratio (Ta) can be described by a characteristic curve of the injector (72).

10. A motor vehicle comprising a fuel cell system (1) as claimed in claim 6.

11. The motor vehicle as claimed in claim 10, characterized in that
the means for determining the outflow quantity (Mout) of fuel flowing out of the compressed gas reservoir (36) in the prespecified time interval comprise
a first pressure sensor (45) which is arranged in the compressed gas reservoir (36) or in a high-pressure line (41) which is arranged between the compressed gas reservoir (36) and the pressure reducer (70), and
a temperature sensor (44) which is arranged in the compressed gas reservoir (36) or in the high-pressure line (41) which is arranged between the compressed gas reservoir (36) and the pressure reducer (70).

12. The motor vehicle as claimed in claim 10, characterized in that
the means for determining the throughflow quantity (Mthrough) of fuel flowing through the injector (72) in the prespecified time interval comprise
a second pressure sensor (46) which is arranged in a medium-pressure line (42) which is arranged between the pressure reducer (70) and the injector (72), and
a third pressure sensor (47) which is arranged in an injection line (43) which is arranged between the injector (72) and the fuel cell unit (3).

13. The motor vehicle as claimed in claim 12, characterized in that
the injector (72) can be actuated by means of pulse width modulation which has a duty ratio (Ta), wherein
a dependency of the throughflow quantity (Mthrough) on a medium pressure (P2) which is measured by the second pressure sensor (46), on an injection pressure (P3) which is measured by the third pressure sensor (47) and on the duty ratio (Ta) can be described by a characteristic curve of the injector (72).
